(19) United States
(12) Patent Application Publication
(10) Pub. No.: US 2013/0032312 A1
(43) Pub. Date: Feb. 7, 2013

(54) VAPOR CHAMBER CAPILLARY FORMATION METHOD AND STRUCTURE THEREOF

(71) Applicant: Chin-Wen WANG, Pingzhen City (TW)

(72) Inventor: Chin-Wen WANG, Pingzhen City (TW)

(73) Assignees: Ching-Chung WANG; Chin-Wen WANG

(21) Appl. No.: 13/198,614

(22) Filed: Aug. 4, 2011

(51) Int. Cl. F28D 15/04; B32B 38/04; B32B 38/08

(52) U.S. Cl. 165/104.26; 156/145

(57) ABSTRACT

A vapor chamber capillary formation method includes providing a base plate and a corresponding cover plate; forming a plurality of support protrusions on the base plate or any internal wall of the cover plate directly; coating a capillary structure onto a surface of the support protrusions, an internal wall of the base plate, and an internal wall of the cover plate; stacking and sealing the base plate and the cover plate with one another to form a cavity; and filling a working fluid into the cavity, and vacuuming and sealing the cavity. In addition, a vapor chamber capillary structure is further disclosed, and the structure can be formed on an internal wall of a casing of the vapor chamber directly, and the support strength and the yield rate of the vapor chamber can be enhanced.

### FIELD OF THE INVENTION

The present invention relates to a vapor chamber, in particular to a capillary structure of the vapor chamber.

### BACKGROUND OF THE INVENTION

Vapor chamber is used extensively for conducting heat of electronic components, since it features a high thermal conductivity, a light weight, a simple structure and a multifunctional application and also can conduct a large quantity of heat without consuming any electric power, and the heat generated by the electronic components can be dissipated quickly to overcome the long-existing heat accumulation problem of the electronic components.

In general, the vapor chamber is substantially in the form of a flat plate having a capillary structure installed on an internal wall of the plate, and a support structure installed in the plate for preventing the surface of the plate from being recessed during the process of vacuuming the interior of the vapor chamber. With a recessed plate, a flat-surface contact between the vapor chamber and the heat-generating electronic component cannot be achieved, and thus the thermal conduction performance of the vapor chamber is affected adversely.

The support structure inside the vapor chamber is usually soldered with a plurality of pillar-shaped objects and combined with the plate, or a thin sheet is bent continuously to form a wavy sheet and then the thin wavy sheet is combined with the plate and used as the support structure. Since the support structure is formed externally first and then combined with the plate by a secondary manufacture, therefore the manufacture incurs more time and labor and a higher cost. In addition, such support structure has the disadvantages of low support strength and poor yield rate.

In view of the aforementioned problems, the inventor of the present invention conducted extensive researches and experiments and finally provided a feasible design to overcome the aforementioned problems.

### SUMMARY OF THE INVENTION

Therefore, it is a primary objective of the present invention to provide a vapor chamber capillary formation method and a structure thereof, and the vapor chamber capillary structure can be manufactured and formed easily to improve the yield rate of a vapor chamber.

Another objective of the present invention is to provide a vapor chamber capillary formation method and a structure thereof, wherein the vapor chamber capillary structure can be formed directly on an internal wall of a casing of the vapor chamber, and the support strength of the vapor chamber can be enhanced.

To achieve the foregoing objectives, the present invention provides a vapor chamber capillary formation method comprising the steps of: (a) providing a base plate and a corresponding cover plate; (b) forming a plurality of support protrusions on the base plate or any internal wall of the cover plate directly; (c) coating a capillary structure onto a surface of the support protrusions, an internal wall of the base plate, and an internal wall of the cover plate; (d) stacking and sealing the base plate and the cover plate with one another to form a cavity; and (e) filling a working fluid into the cavity, and vacuuming and sealing the cavity.

To achieve the foregoing objectives, the present invention provides a vapor chamber capillary structure, comprising: a base plate; a cover plate, stacked and sealed onto the base plate, and having a cavity formed between the cover plate and the base plate; a plurality of support protrusions, formed on the base plate and the cover plate or an internal wall of the base plate or the cover plate directly; a capillary structure, coated onto a surface of the support protrusions, an internal wall of the base plate and an internal wall of the cover plate; and a working fluid, filled into the cavity.

Compared with the prior art, the present invention forms the support protrusions on the base plate, the cover plate or the internal walls of both base plate and cover plate directly, so that there is no issue of separating or peeling off the support protrusion caused by a poor manufacture, since the support protrusions are formed by punching from the internal wall of the base plate. In addition, the support strength of the vapor chamber can be maintained permanently. The way of forming the support protrusions quickly by the punching method in accordance with the present invention not only saves manufacturing time and lowers costs, but also improves the practicality of applications.

### BRIEF DESCRIPTION OF THE DRAWINGS

FIG. 1 is a flow chart of a vapor chamber capillary formation method of the present invention;

FIG. 2 is an exploded view of a vapor chamber capillary structure in accordance with a first preferred embodiment of the present invention;

FIG. 3 is a schematic view of a vapor chamber capillary structure in accordance with the first preferred embodiment of the present invention;

FIG. 4 is a cross-sectional view of a vapor chamber capillary structure in accordance with the first preferred embodiment of the present invention;

FIG. 5 is a schematic perspective view of a vapor chamber capillary structure in accordance with the first preferred embodiment of the present invention;

FIG. 6 is a schematic view of a vapor chamber capillary structure in accordance with a second preferred embodiment of the present invention;

FIG. 7 is a schematic view of a vapor chamber capillary structure in accordance with a third preferred embodiment of the present invention;

FIG. 8 is a schematic view of a vapor chamber capillary structure in accordance with a fourth preferred embodiment of the present invention;

FIG. 9 is a cross-sectional view of a vapor chamber capillary structure in accordance with the fourth preferred embodiment of the present invention; and

FIG. 10 is a schematic view of another implementation of a vapor chamber of the present invention.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

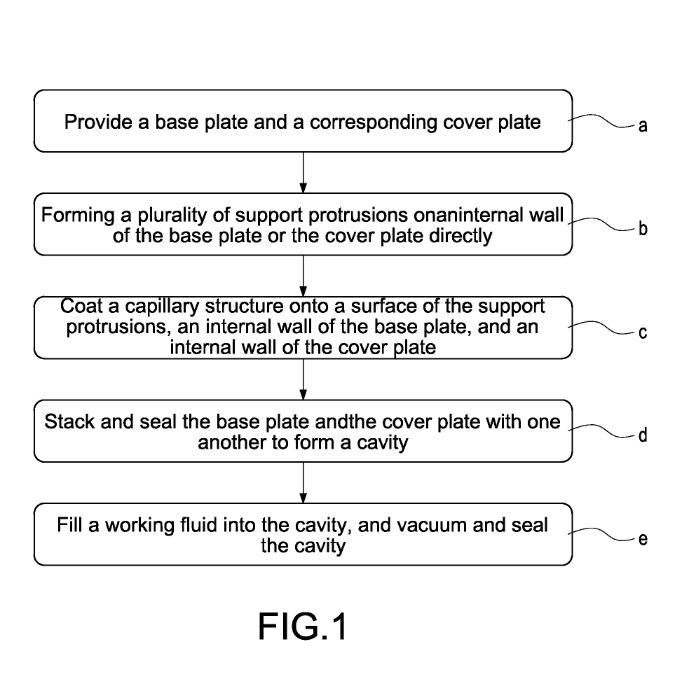

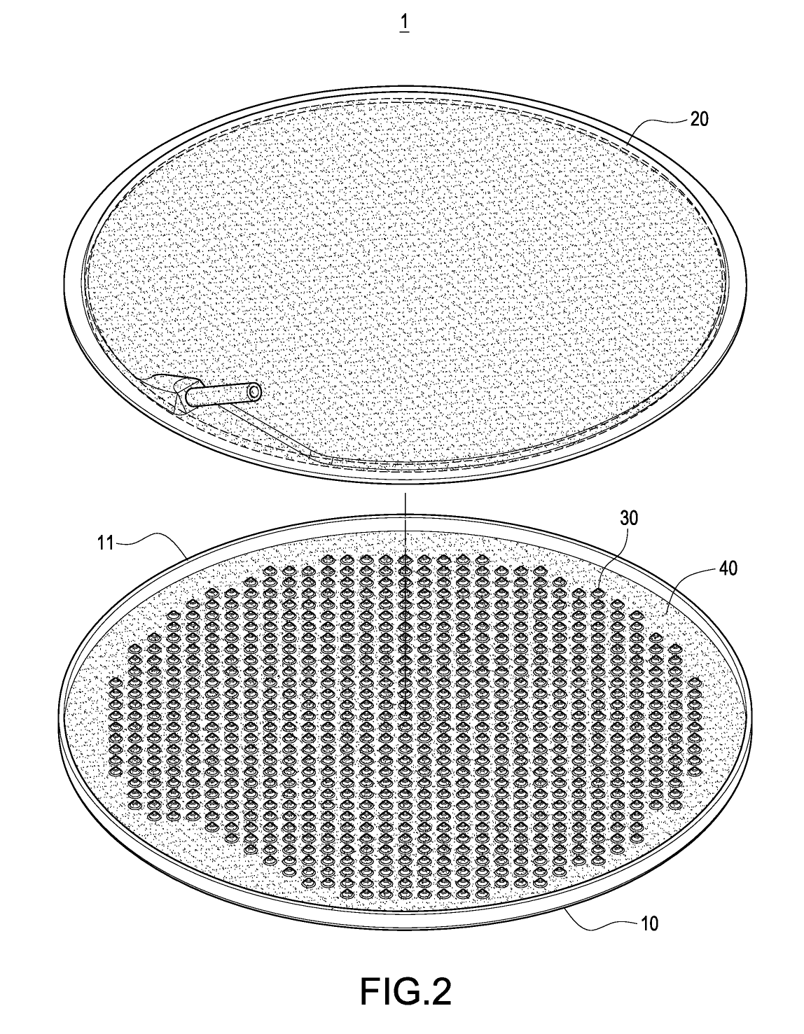

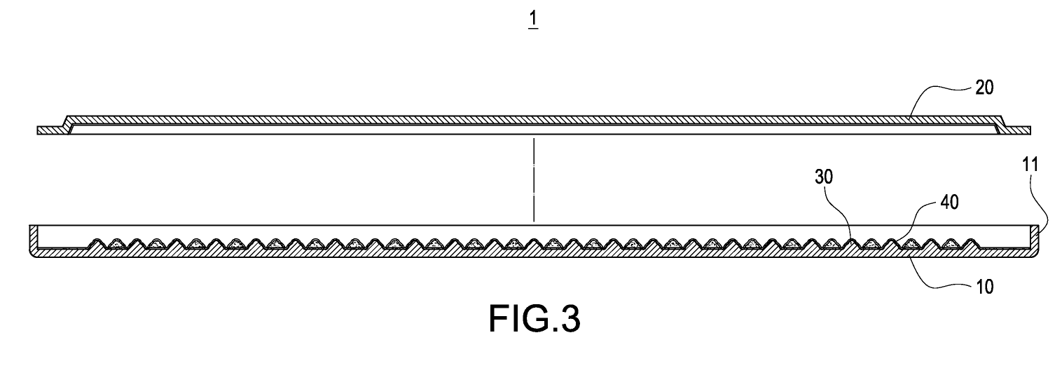

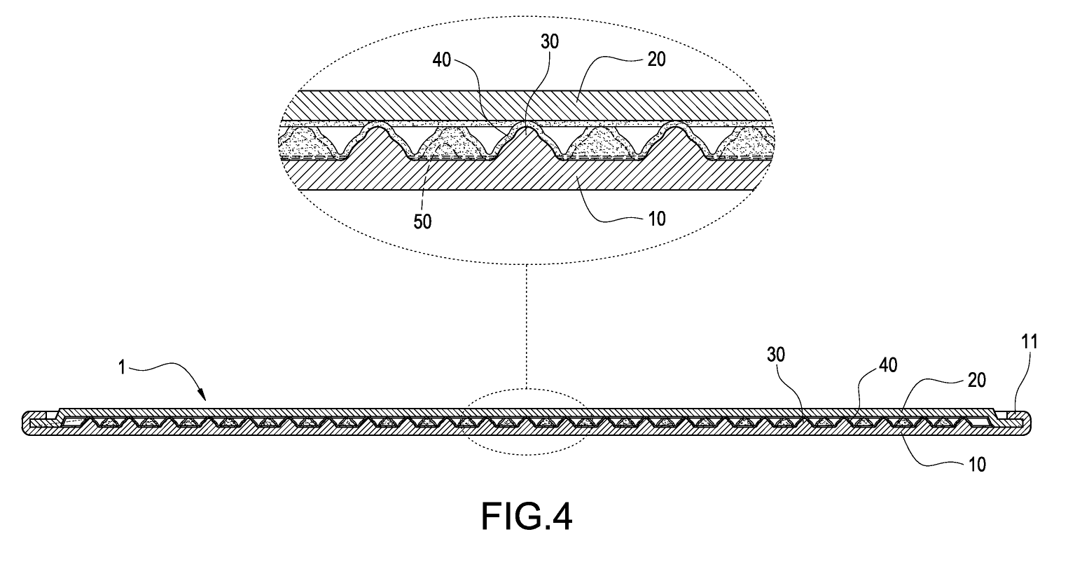

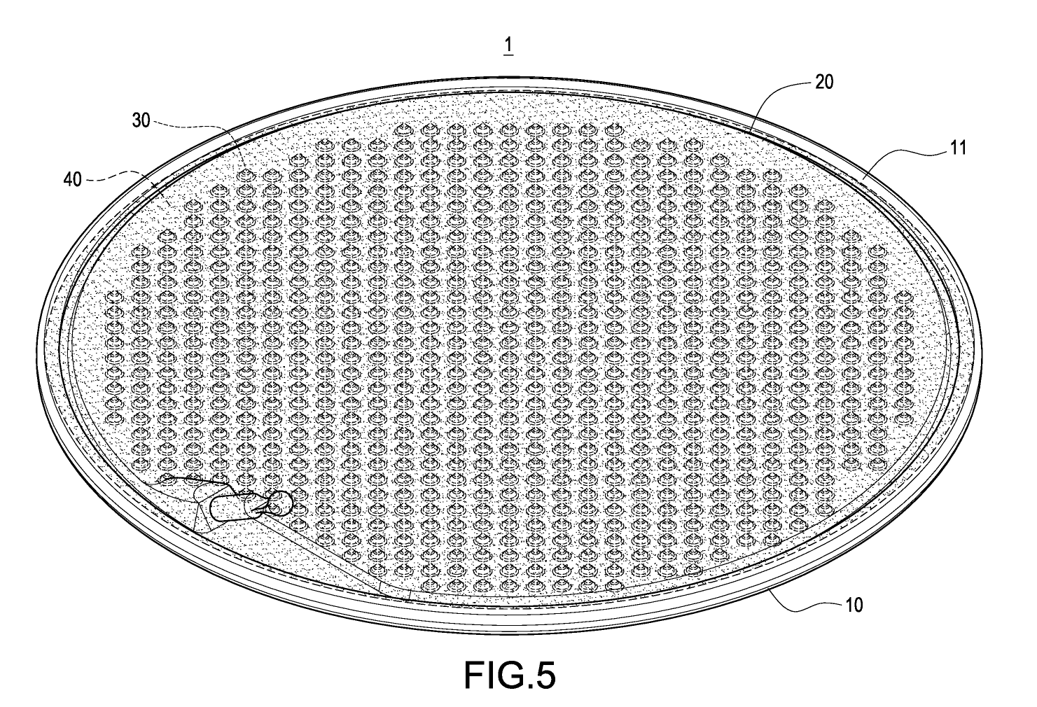

With reference to FIG. 1 for the flow chart of a vapor chamber capillary formation method of the present invention, and FIGS. 2 to 5 for the exploded view, the schematic view, the cross-sectional view and the schematic perspective view of the in accordance with the first preferred embodiment of the present invention respectively, a vapor chamber 1 comprises a base plate 10, a cover plate 20, a plurality of support protrusions 30, a capillary structure 40 and a working fluid 50.

The vapor chamber capillary formation method of the present invention comprises the steps of; providing a base plate 10 and a corresponding cover plate 20 (Step a); forming a plurality of support protrusions 30 on the base plate 10, the cover plate 20 or an internal wall of the base plate 10 or the cover plate 20 directly (Step b); coating a capillary structure 40 onto a surface of the support protrusions 30, the internal wall of the base plate 10 and the internal wall of the cover plate 20 (Step c); stacking and sealing the base plate 10 and the cover plate 20 with each other to form a cavity 100 (Step d); and filling a working fluid 50 into the cavity 100 and vacuuming and sealing the cavity 100 (Step e).

The base plate 10 and the cover plate 20 are made of metal of a good thermal conductivity, and their shape can be circular, but the invention is not limited to the circular shape only. In the step (b) of this preferred embodiment, the support protrusions 30 are formed on the internal wall of the base plate 10, and the cover plate 20 is stacked onto and sealed with the base plate 10 to define a cavity 100 between the base plate 10 and the cover plate 20. In addition, the base plate 10 has a flange 11 bent inwardly and folded from an external surface of the base plate 10 and at a position where the cover plate 20 is coupled.

The support protrusions 30 are arranged with an interval apart from one another, and each of the support protrusions 30 is substantially a semicircular cone formed by punching from the internal wall of the base plate 10. The support protrusions 30 are formed on the internal wall directly; in other words, the support protrusions 30 are punched from the internal wall of the base plate 10 and formed on the internal wall of the base plate 10 directly. Of course, the support protrusions 30 can also be integrally formed on the internal wall by other equivalent formation methods such as a casting method or a planning method.

The capillary structure 40 is coated onto a surface of the support protrusions 30, an internal wall of the base plate 10, and an internal wall of the cover plate 20. The capillary structure 40 can be formed by sintering a metal powder onto the internal walls, but the capillary structure 40 of the invention is not limited to such arrangement only. For example, a metal mesh or a combination of the aforementioned two structures can be used instead. It is noteworthy to point out that the capillary structure 40 covers the whole surface of the support protrusions 30 completely.

Finally, the working fluid 50 is filled into the cavity 100, and then the cavity 100 is vacuumed and sealed to complete the manufacture of the vapor chamber 1.

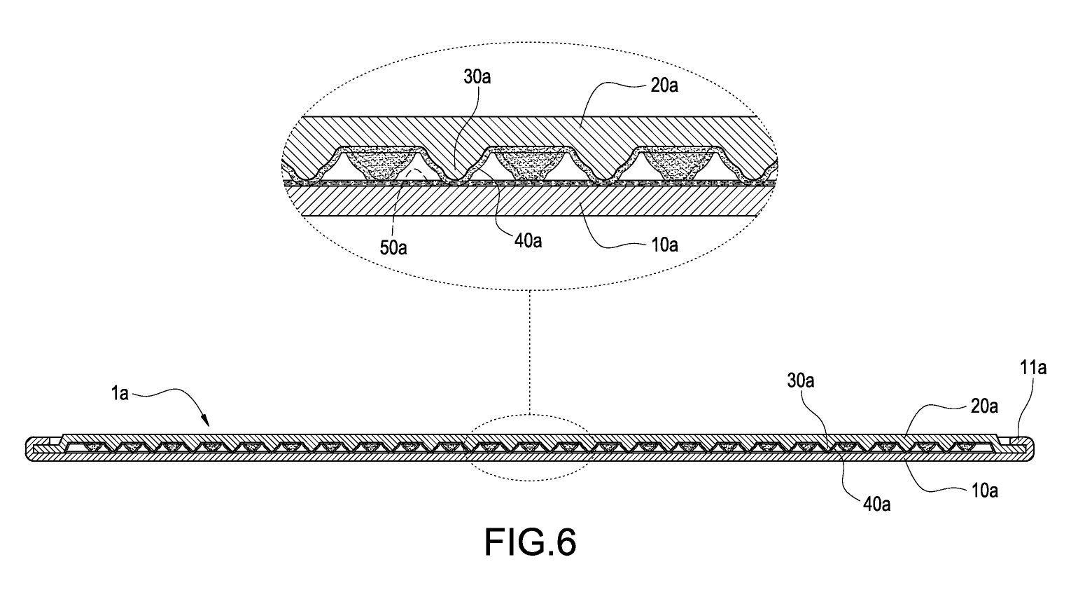

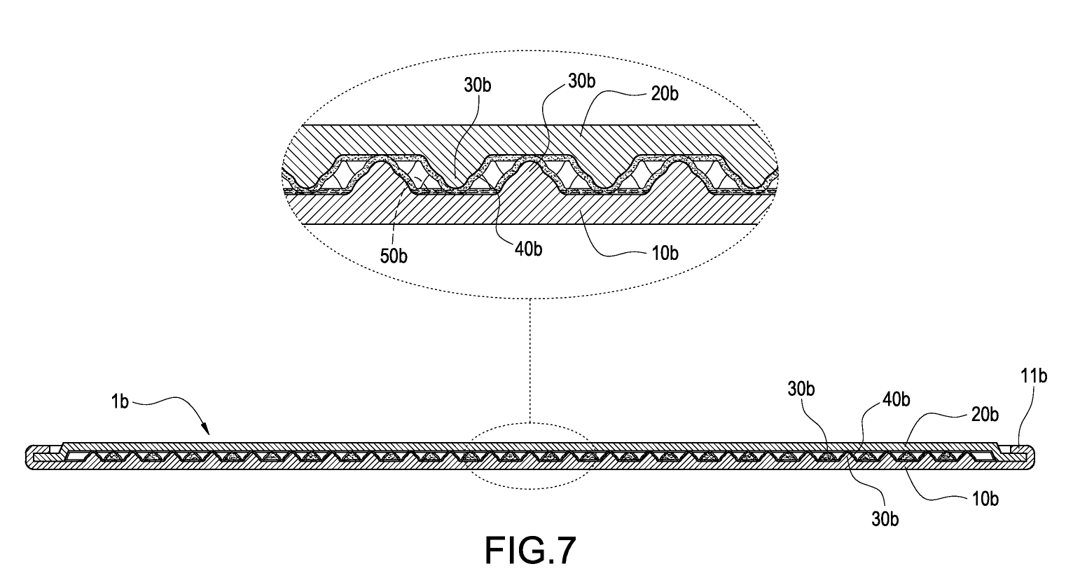

With reference to FIGS. 6 and 7 for the vapor chamber capillary structure in accordance with the second and third preferred embodiments of the present invention respectively, these two preferred embodiments are substantially the same. In FIG. 6, the vapor chamber la comprises a base plate 10a, a cover plate 20a, a plurality of support protrusions 30a, a capillary structure 40a and a working fluid 50a. Unlike the first preferred embodiment, the support protrusions 30a of this preferred embodiment are formed on the internal wall of the cover plate 20a. In other words, the internal wall of the cover plate 20a has the support protrusions 30a formed directly thereon.

In FIG. 7, the vapor chamber lb comprises a base plate 10b, a cover plate 20b, a plurality of support protrusions 30b, a capillary structure 40b and a working fluid 50b. Unlike the first preferred embodiment, the support protrusions 30b are formed on the internal walls of the base plate 10b and the cover plate 20b, and the support protrusions 30b on the base plate 10b and the cover plate 20b are arranged alternately. In other words, the internal walls of the base plate 10b and the cover plate 20b have the support protrusions 30b formed directly thereon.

It is noteworthy to point out that the internal walls of the base plates 10, 10a, 10b or the cover plates 20, 20a, 20b abut the support protrusions 30, 30a, 30b in the aforementioned preferred embodiment.

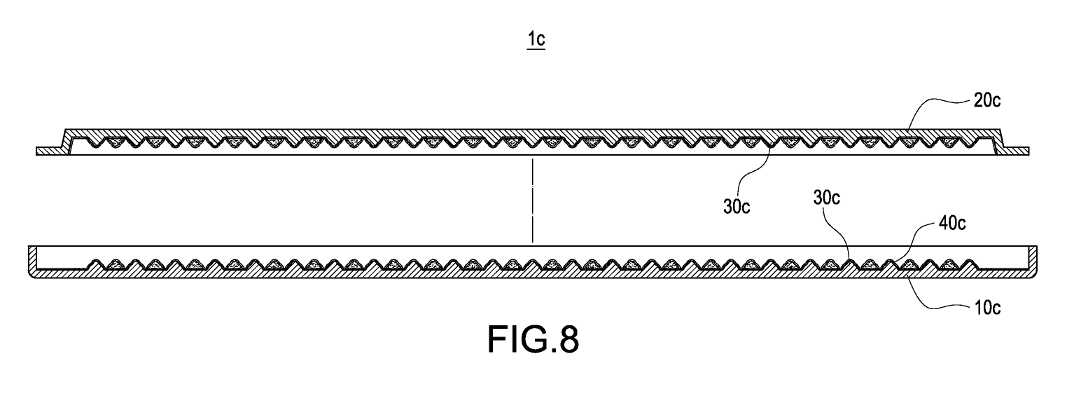

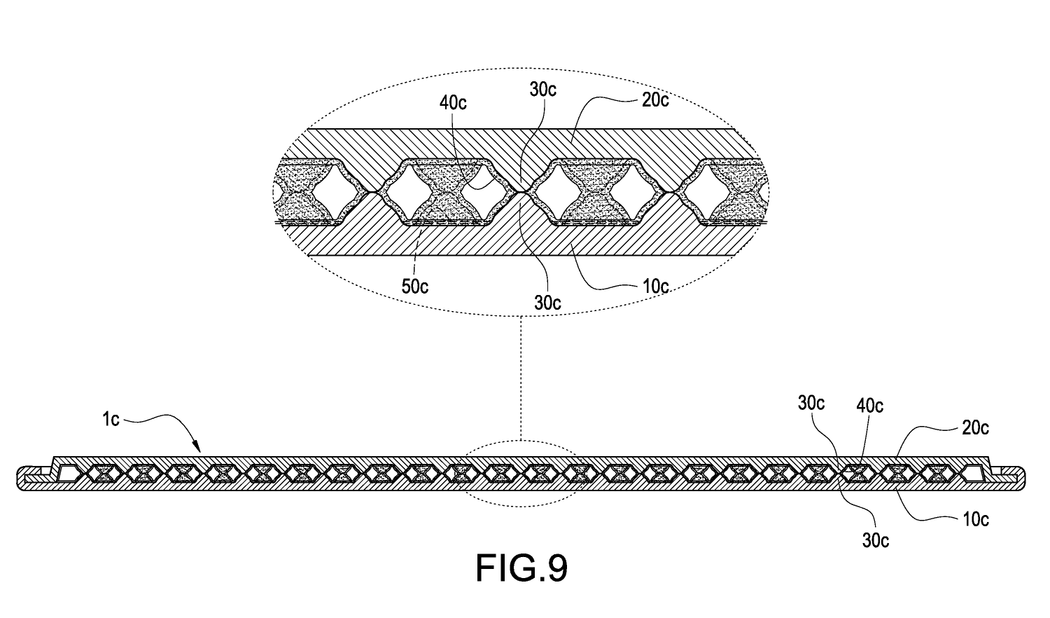

With reference to FIGS. 8 and 9 for a vapor chamber capillary structure in accordance with the fourth preferred embodiment of the present invention, the vapor chamber 1c comprises a base plate 10c, a cover plate 20c, a plurality of support protrusions 30c, a capillary structure 40c and a working fluid 50c, and the support protrusions 30c are formed on the base plate 10b and the cover plate 20b directly. Unlike the third preferred embodiment, the support protrusions 30c are formed at corresponding positions on the internal walls of the base plate 10c and the cover plate 20c. After the base plate 10c and the cover plate 20c are stacked and sealed, the support protrusions 30c disposed on the base plate 10c and the support protrusions 30c disposed on the cover plate 20c abut one another.

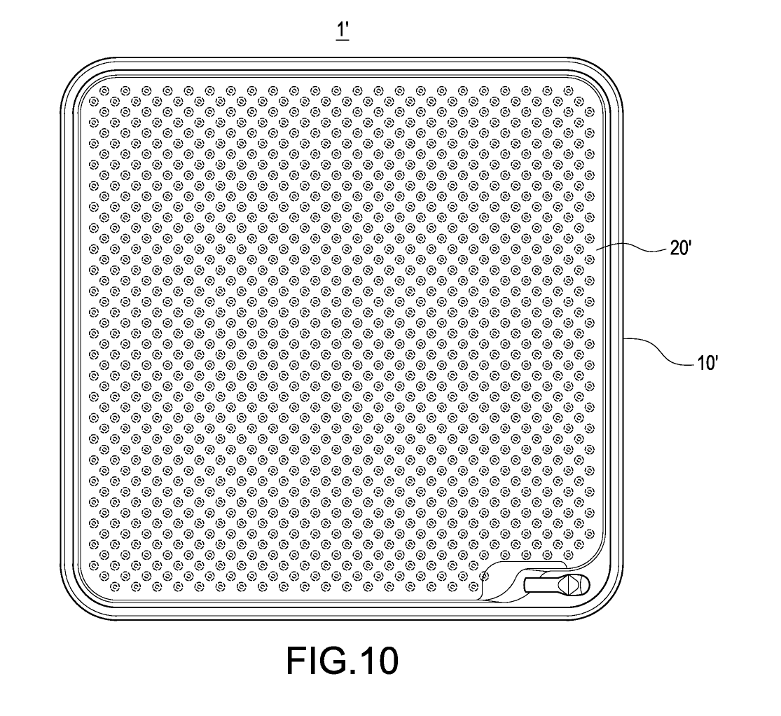

With reference to FIG. 10 for another implementation of a vapor chamber of the present invention, this preferred embodiment is substantially the same as the first preferred embodiment, except the shape and appearance of the vapor chamber V. In this preferred embodiment, both base plate 10′ and cover plate 20′ are square shaped and combined to form a square vapor chamber 1′.

While the invention has been described by means of specific embodiments, numerous modifications and variations could be made thereto by those skilled in the art without departing from the scope and spirit of the invention set forth in the claims.

What is claimed is:

1. A vapor chamber capillary formation method, comprising the steps of:
(a) providing a base plate and a corresponding cover plate;
(b) forming a plurality of support protrusions on an internal wall of the base plate or the cover plate directly;
(c) coating a capillary structure onto a surface of the support protrusions, an internal wall of the base plate, and an internal wall of the cover plate;
(d) stacking and sealing the base plate and the cover plate with one another to form a cavity; and
(e) filling a working fluid into the cavity, and vacuuming and sealing the cavity.

2. The vapor chamber capillary formation method of claim 1, wherein the support protrusions are formed on the internal wall of the base plate in the step (b).

3. The vapor chamber capillary formation method of claim 1, wherein the support protrusions are formed on the internal wall of the cover plate in the step (b).

4. The vapor chamber capillary formation method of claim 1, wherein the support protrusions are formed alternately on the corresponding internal walls of the base plate and the cover plate in the step (b).

5. The vapor chamber capillary formation method of claim 1, wherein the support protrusions abut the internal walls of the base plate or the cover plate in the step (d).

6. The vapor chamber capillary formation method of claim 1, wherein the support protrusions are disposed with an interval apart from one another, and each of the support protrusions is substantially a semicircular cone.

7. The vapor chamber capillary formation method of claim 1, wherein the support protrusions are formed by punching from the internal wall of the base plate or the cover plate in the step (b), such that the support protrusions are formed on the internal walls directly.

8. The vapor chamber capillary formation method of claim 1, wherein the support protrusions are formed at corresponding positions of the internal walls of the base plate and the cover plate the step (d), and the support protrusions disposed on the base plate and the support protrusions disposed on the cover plate abut one another.

9. The vapor chamber capillary formation method of claim 1, wherein the capillary structure as described in the step (c) is formed by sintering a metal powder onto the internal walls.

10. A vapor chamber capillary structure, comprising:
a base plate;
a cover plate, stacked and sealed onto the base plate, and having a cavity formed between the cover plate and the base plate;
a plurality of support protrusions, formed on the base plate and the cover plate or an internal wall of the base plate or the cover plate directly;
a capillary structure, coated onto a surface of the support protrusions, an internal wall of the base plate and an internal wall of the cover plate; and
a working fluid, filled into the cavity.

11. The vapor chamber capillary structure of claim 10, wherein the support protrusions are formed on the internal wall of the base plate or the internal wall of the cover plate.

12. The vapor chamber capillary structure of claim 10, wherein the support protrusions are formed on the internal walls of the base plate and the cover plate.

13. The vapor chamber capillary structure of claim 12, wherein the support protrusions formed on the base plate and the cover plate are arranged alternately with one another.

14. The vapor chamber capillary structure of claim 12, wherein the support protrusions are formed at corresponding positions of the internal walls of the base plate and the cover plate, and the support protrusions disposed on the base plate and the support protrusions disposed on the cover plate abut one another.

15. The vapor chamber capillary structure of claim 10, wherein the support protrusions are arranged with an interval apart from one another, and each of the support protrusions is substantially a semicircular cone, and the support protrusions are formed by punching from the internal walls of the base plate or the cover plate directly.

16. The vapor chamber capillary structure of claim 10, wherein the internal wall of the base plate or the cover plate abuts the support protrusions.

17. The vapor chamber capillary structure of claim 10, wherein the capillary structure is formed by sintering a metal powder onto the support protrusions and the internal walls.

18. The vapor chamber capillary structure of claim 17, wherein the capillary structure covers the whole surface of the support protrusions completely.

19. The vapor chamber capillary structure of claim 10, wherein the base plate includes a flange bent inwardly and folded from an external surface of the base plate and at a position wherein the cover plate is coupled.

20. The vapor chamber capillary structure of claim 10, wherein the base plate and the cover plate are both in a circular or square shape.
